(19) United States
(12) Patent Application Publication
(10) Pub. No.: US 2003/0034304 A1
(43) Pub. Date: Feb. 20, 2003

(54) N-acetylated chitosan membranes

(76) Inventors: Robert Y.M. Huang, Waterloo (CA); Rajinder Pal, Waterloo (CA); Go Young Moon, Kitchener (CA)

Correspondence Address: Gowling Lafleur Henderson LLP, Suite 4900, Commerce Court West, Toronto, ON, M5LIJ3, CA

(21) Appl. No.: 09/930,949

(22) Filed: Aug. 17, 2001

(51) Int. Cl. B01D 61/36; B01D 69/10; B01D 69/12

(52) U.S. Cl. 210/640; 210/483; 210/488; 210/490; 210/500.21

(57) ABSTRACT

A composite membrane is provided comprising a porous substrate membrane coated with a membrane comprising N-acetylated chitosan. The N-acetylated chitosan is characterized by a degree of N-acetylation greater than 50% and less than 90%. The porous substrate membrane includes any of polyvinylidene fluoride, polysulfone, and a ceramic. In this respect, composite membrane is provided comprising: a first layer including N-acetylated chitosan, and a second layer including a porous substrate membrane, wherein the first layer is coated upon the second layer. A method of forming a composite membrane is also provided comprising the steps of: forming a porous substrate membrane, depositing chitosan solution on the porous substrate membrane to form a first intermediate, drying the first intermediate to form an intermediate composite membrane including a chitosan membrane, and acetylating the chitosan membrane. A method for separating a liquid mixture including a polar liquid and a non-polar liquid is further provided, comprising the steps of: providing a composite membrane comprising a first layer including N-acetylated chitosan, and a second layer including a porous substrate membrane, wherein the first layer is deposited upon the second layer, and contacting the mixture with the first layer of the composite membrane.

### FIELD OF INVENTION

The present invention relates to a novel composite membrane material and, more particularly, novel composite membrane material comprising N-acetylated chitosan.

### BACKGROUND OF THE INVENTION

In recent years, there has been increased interest in the use of pervaporation membrane separation techniques for the selective separation of organic liquid mixtures because of their high separation efficiency and flux rates coupled with potential savings in energy costs.

Pervaporation is the separation of liquid mixtures by partial vaporization through a non-porous permselective membrane. During its transport through the membrane, components of the liquid mixture diffusing through the membrane undergo a phase change, from liquid to vapor. This phase change occurring through the membrane makes the pervaporation process unique among membrane processes. The permeate, or product, is removed as a low-pressure vapor, and, thereafter, can be condensed and collected or released as desired.

In a typical pervaporation process, a liquid mixture feed is contacted with one side of a dense non-porous membrane. After dissolving in and diffusing through the membrane, the permeate is removed from the downstream side in the vapor phase under vacuum or swept out in a stream of inert carrier gas. Separation of individual components of the liquid mixture feed requires that physicochemical interactions with the membrane be different for the individual components. Such interactions affect the permeation rate of each of the individual components through the membrane, thereby giving rise to separation.

Membrane performance in the pervaporation context is measured by its selectivity. The selectivity of a membrane for the separation of a mixture comprised of components A and B may be described by the separation factor ⁴ which is defined as follows:

$$∝ = \frac{Y}{( 1 - Y )} \frac{1 - X}{( X )}$$

where X and Y are the molar fractions of the more permeable component A in the feed and permeate, respectively. In addition to being selective, however, it is desirable for a membrane to have good permeability. Otherwise, despite high selectivity, acceptable separations will not be achieved where the membrane is relatively impermeable for components in the liquid feed.

Pervaporation membrane processes are finding their application niches in the chemical industries as a process for breaking azeotropic concentration after distillation or as an intermediate between distillation processes. Most of the pervaporation studies published in journals have focused on the discovery and the modification of new membrane materials for specific mixture separation. After the successful industrialization of plasma-polymerized and cross-linked PVA membranes for alcohol dehydration systems, much research attention has been paid to the polysaccharide natural polymers such as chitosan and alginate because of their reasonably good hydrophilicities and film form properties.

Chitin, poly-(1→4)-β-N-acetyl-D-glucosamine, the most abundant natural polymer next to cellulose, is widely found in skeletons of crustaceans such as shrimps, crabs and lobsters, and in cell walls of microorganisms. Seafood waste from shrimps, lobsters and crabs generally contains 10-15% chitin. Chitin and, its deacetylated derivative, chitosan are finding applications in pharmaceutical system such as surgical suture and drug delivery, enzyme immobilization, and metal ion chelation. Studies of chitin as a membrane material have been limited compared to chitosan because of difficulty of dissolution in most organic solvents.

To achieve chemically resistant and mechanically stronger membrane, chitosan can be modified to chitin using acetic anhydride. Among many reactions involved in chitosan modification, the acylation of chitosan has gained special interest. Hirano et al. obtained chitin (N-acetylchitosan) gel from chitosan gel by treating chitosan gel with acetic anhydride (about 10 mol/glucosamine residue (GlcN) in 70% aqueous methanol solution at room temperature for 18 hours, S. Hirano, R. Yamaguchi, N. Fukui, M. Iwata, Biological Gels: The Gelation of Chitosan and Chitin, in C. G. Gebelein (Ed.) Biotechnology and Polymers, Plenum Press, New York, 1991. Zeng and Ruchenstein [28] successfully prepared porosity-controllable chitin membranes by acetylating chitosan membranes in various anhydrous solutions, X. Zeng, E. Ruchenstein, Control of Pore Sizes in Macroporous Chitosan and Chitin Membranes, Ind. Eng. Chem. Res. 35 (1996) 4169-4175.

### SUMMARY OF THE INVENTION

The present invention provides a membrane including N-acetylated chitosan deposited upon a porous substrate.

In another aspect, the invention provides a composite membrane comprising a first layer including N-acetylated chitosan, and a second layer including a porous substrate membrane, wherein the first layer is deposited upon the second layer.

In another aspect, the invention provides a composite membrane comprising a first layer including chitin, and a second layer including a porous substrate membrane, wherein the first layer is deposited upon the second layer.

In yet another aspect, there is provided a method of forming a composite membrane comprising the steps of (i) forming a porous substrate membrane, (ii) depositing chitosan solution on the porous substrate membrane to form a first intermediate, (iii) drying the first intermediate to form an intermediate composite membrane including a chitosan membrane, and (iv) converting the chitosan membrane into a chitin membrane.

In yet another aspect, there is provided a method for separating a liquid mixture including a polar liquid and a non-polar liquid, comprising the steps of (i) providing a composite membrane comprising a first layer including N-acetylated chitosan, and a second layer including a porous substrate membrane, wherein the first layer is deposited upon the second layer, and (ii) contacting the mixture with the first layer of the composite membrane.

### BRIEF DESCRIPTION OF THE DRAWINGS

The invention will be better understood when consideration is given to the following detailed description. Such description makes reference to the annexed drawings wherein:

FIG. 1 is a schematic diagram of the pervaporation apparatus used in Examples 1 and 2;

FIG. 2 is a Scanning Electron Micrograph photograph of an embodiment of a composite membrane of the present invention, comprising a first layer including N-acetylated chitosan and a second layer including polyetherimide;

FIG. 3 is an enlarged view of Detail “A” of FIG. 2;

FIG. 4 is a graph illustrating total flux as a function of ethanol feed concentration during pervaporation of the ethanol/toluene mixtures through N-acetylated chitosan membranes as well as 99% de-acetylated chitosan;

FIG. 5 is a graph illustrating separation factor of ethanol/toluene mixtures as a function of ethanol feed concentration during the pervaporations from which the flux data of FIG. 4 was derived;

FIG. 6 is a graph illustrating total flux for a 70 wt %/30 wt % ethanol/toluene mixture as a function of temperature during pervaporation of the ethanol/toluene mixture through N-acetylated chitosan membranes as well as 99% de-acetylated chitosan; and

FIG. 7 is a graph illustrating total flux and separation factor for methanol/toluene mixtures as a function of methanol feed concentration during pervaporation of the methanol/toluene mixtures through N-acetylated chitosan membranes as well as 99% de-acetylated chitosan;

### DETAILED DESCRIPTION

The present invention relates to a novel composite membrane material comprising N-acetylated chitosan.

In one embodiment, the novel membrane material is a composite membrane comprising a porous substrate coated with a membrane comprising chitin or N-acetylated chitosan. In this respect, the composite material comprises a first layer and a second layer, wherein the first layer includes chitin or N-acetylated chitosan and the second layer includes a porous substrate. The first layer is deposited, coated or cast on the second layer. The degree of acetylation of N-acetylated chitosan of the composite membrane is at least 50%. In another embodiment, the degree of acetylation of N-acetylated chitosan of the composite membrane is within the range of from about 50% to about 90%. Below about 50% acetylation degree, the first layer does not possess the desired strength. Above 90% acetylation, the first layer becomes brittle and rigid.

The porous substrate provides mechanical reinforcement to the N-acetylated chitosan or chitin layer. The porous substrate includes a porous substrate membrane. The porous substrate membrane may be comprised of any one of several suitable materials, including polyetherimide, polyvinylidene fluoride (PVDF), polysulfone, polyether sulfone, polyacrylonitrile, and ceramics. The first layer is deposited, coated or cast upon the porous substrate membrane.

In one embodiment, the porous substrate includes a porous substrate membrane and a polyester non-woven fabric for additional support. The porous substrate membrane is deposited, coated, or cast upon the polyester non-woven fabric. Likewise, the first layer is deposited, coated, or cast upon the porous substrate membrane.

In one embodiment, the porous substrate may be treated by contacting the substrate with a hydrophilic polymer, for enhancing hydrophilicity of the polymer. An example of a suitable hydrophilic polymer is polyvinyl alcohol.

In one embodiment, after treatment with the hydrophilic polymer, the porous substrate is dried and then may be cross-linked.

The first layer of the composite membrane has a thickness from about 0.5 μm to about 20 μm. The second layer has a thickness from about 5 μm to about 300 μm.

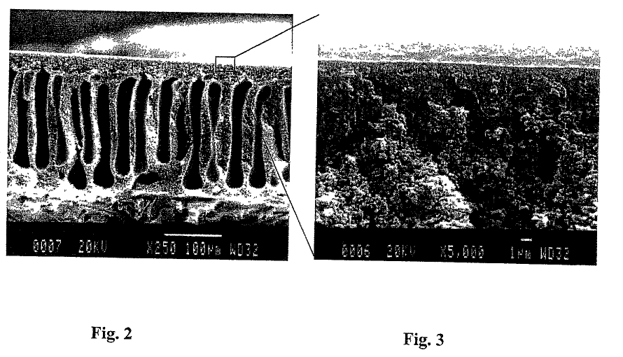

SEM photographs of a composite membrane comprising a first layer including an N-acetylated chitosan and a second layer including a porous substrate including a polyetherimide membrane are illustrated in FIGS. 2 and 3. The thickness of the composite membrane that is illustrated is about 300 μm, where the thickness of the first layer is about 3 μm.

The composite membrane includes an interface, separating the first layer from the second layer. At the interface, the first layer and the second layer interact to form a composite asymmetric membrane. It is believed that there is no permanent chemical change in either of the first and second layers when the second layer is coated by the first layer, or, in other words, when the first layer is deposited upon the second layer. The first layer physically adheres to the second layer.

The composite membrane of the present invention can be prepared by a wet process which comprises the steps of:

(i) forming a porous substrate membrane;

(ii) depositing a chitosan solution on the porous substrate membrane to form a first intermediate;

(iii) drying the first intermediate to form an intermediate composite membrane including a chitosan membrane; and

(iv) converting the chitosan membrane to a chitin membrane.

The chitosan solution or film maybe deposited or coated on the porous substrate membrane by way of a dip coating technique or by way of aid of a casting knife.

In one embodiment of step (iv),the conversion proceeds by way of acetylation. In one embodiment, acetylation can proceed by way of immersing the intermediate composite membrane in solution comprising acetyl radicals or acetyl groups. Suitable donors of acetyl groups include acetyl chloride and acetic anhydride. By immersing the intermediate composite membrane formed in step (iii) in a solution comprising acetyl chloride and/or acetic anhydride, the chitosan membrane of the intermediate composite membrane becomes acetylated. In this respect, the chitosan membrane becomes converted to N-acetylated chitosan membrane or chitin membrane.

By way of example, the following describes a method of preparing a composite membrane, where the first layer is comprised of N-acetylated chitosan and the second layer is comprised of a porous substrate including a polyetherimide membrane. A polyetherimide casting solution was cast upon a non-woven fabric, such as a polyester non-woven fabric to form a porous substrate. The porous substrate was then coated with a chitosan solution to form an intermediate composite membrane comprising a first layer including a chitosan membrane and a second layer including a porous substrate. The intermediate composite membrane was then immersed in a solution including compositions effective to cause acetylation of the chitosan membrane of the intermediate composite membrane. Example of suitable solutions include acetic anhydride in alcohol solution or acetyl chloride in alcohol solution.

The composite membrane of the present invention is useful in the pervaporation separation of liquid mixtures comprising polar and non-polar components, such as a liquid alcohol or alcohols mixed with one or more non-polar organic liquids.

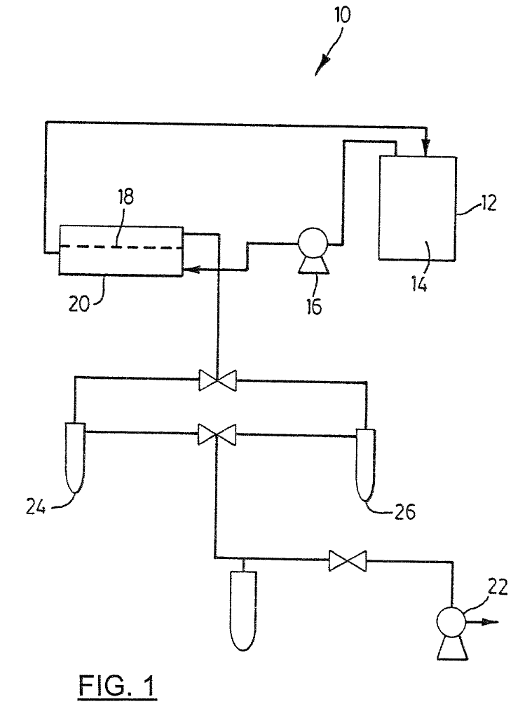

A schematic diagram of a pervaporation apparatus 10 used in the illustrative examples described below is shown in FIG. 1. The feed solution temperature in the tank 12 was controlled to the desired value, and the feed solution 14 is circulated using the feed pump 16. The membrane was placed on the porous stainless steel support 18 of the membrane cell 20 and sealed. The effective area of the membrane in contact with the feed stream was 14.2 cm². Pervaporation was initiated by switching on the circulation pump 16 and vacuum pump 22, the pressure at permeate side was maintained around 3 mbar. Permeate was collected in the cold trap 24 which were immersed in liquid nitrogen. The pervaporation apparatus 10 was run for at least 2 hours to reach the equilibrium state before starting to measure permeate. When sufficient permeate was collected in the cold trap 24, the vacuum valve 28 was switched to the parallel trap 26 to collect a further sample. The cold trap 24 containing the permeate was warmed up to ambient temperature, then removed, and weighed to determine the flux and the contents were analysed for permeate composition.

Using this pervaporation apparatus, composite membranes comprising a first layer including N-acetylated chitosan and a second layer comprising a porous polyetherimide substrate were shown to have relatively good permselectivity during pervaporation of ethanol/toluene and methanol/toluene mixtures. In this respect, the present invention will be further described with reference to the following non-limitative examples.

### EXAMPLE 1

Porous polyetherimide (PEI) membranes were prepared via the wet phase inversion technique from casting solutions containing 18 wt.% polyetherimide, 77 wt.% N-dimethyl-acetamide (DMAc), and 5 wt.% ethylene glycol. The casting solution was cast onto a polyester non-woven fabric held on a glass plate with the aid of a casting knife to form a porous substrate including a PEI membrane deposited on the fabric. The cast film was immediately immersed into a coagulation bath. The resulting membrane was washed in de-ionized water thoroughly and air-dried completely at ambient temperature. The initial substrate showed a pure water permeation rate of 115.8 kg/m² h at transmembrane pressure of 100 psi and operating temperature 22° C. Most of the water flux tests were performed in replicate to achieve accuracy. The porous substrate was soaked in 0.1 wt.% polyvinyl alcohol binding solution for 1 hour, dried, and then cross-linked in 80 wt.% aqueous acetone solution containing 1.6 wt.% glutaraldehyde and 0.05 wt. % HCl for 1 hour in order to enhance the wettability of the membrane surface. After drying, the substrate was then coated with a thin film of chitosan using a dip coating technique by immersing the substrate into 0.5% chitosan solution consisting of 4 wt. % acetic acid. The resulting material was then dried in the oven of 60° C. for 100 minutes to form an intermediate composite membrane.

To convert the resultant chitosan membrane to a N-acetylated chitosan membrane, an intermediate composite membrane, prepared as described above, was immersed in a first solution comprising 4 mol acetic anhydride per glucosamine in methanol/ethanol for 24 hours. Similarly, a further intermediate composite membrane was immersed in a second solution comprising 7 mol acetic anhydride per glucosamine in methanol/ethanol for 24 hours. The membranes were then washed thoroughly in deionized water for 1 day, and dried for further use.

A BOMEM Michelson series 100 FT-IR spectrometer was used to assist in determining the degree of N-acetylation of each of the above-formed membranes, byway of calculation using the method prescribed in G. A. F. Roberts, Determination of the degree of N-acetylation of chitin and chitosan, in R. A. A. Muzarelli, M. G. Peter (Eds.), Chitin Handbook, European Chitin Society, 1997. For the first composite membrane formed after immersing the intermediate into the first solution comprising 4 mol acetic anhydride per glucosamine in methanol/ethanol, the degree of N-acetylation of the N-acetylated chitosan membrane of the composite membrane was found to be about 70%. For the second composite membrane formed after immersing the intermediate into the first solution comprising 7 mol acetic anhydride per glucosamine in methanol/ethanol, the degree of N-acetylation of the N-acetylated chitosan membrane of the composite membrane was found to be about 90%.

FIGS. 4, 5, and 6 show the pervaporation characteristics of pure (de-acetylation degree of 99%) and N-acetylated chitosan composite membranes for ethanol/toluene mixtures. Two N-acetylated chitosan composite membranes of different degrees of N-acetylation were studied. The first N-acetylated chitosan membrane was described above and was prepared by immersing the above-described intermediate composite membrane into a first solution comprising 4 mol acetic anhydride per glucosamine in methanol/ethanol to form a N-acetylated chitosan membrane with a degree of N-acetylation of about 70%, and is identified in FIGS. 4, 5, and 6 as “4 mol AA”. The second N-acetylated chitosan membrane was described above and was prepared by immersing the above-described intermediate composite membrane into a first solution comprising 7 mol acetic anhydride per glucosamine in methanol/ethanol to form a N-acetylated chitosan membrane with a degree of N-acetylation of about 90%, and is identified in FIGS. 4, 5, and 6 as “7 mol AA”. The pure chitosan composite membrane was prepared in the same manner as the N-acetylated chitosan membranes, with the exception that the immersion into the acetic anhydride solution step was avoided.

FIG. 4 illustrates that permeation flux of pure chitosan membrane does not vary significantly from 10% ethanol to 50% ethanol mixture. Without wishing to be bound by theory, this is likely attributable to the fact that the chitosan membrane does not become significantly swollen in ethanol.

Pure chitosan membrane showed the highest permeation fluxes through the feed concentration range, compared to those of the N-acetylated membranes. Without wishing to be bound by theory, the lower fluxes associated with the N-acetylated membranes may be attributable to the strong inter or intramolecular bonding among acetyl functional groups. This strong bonding may contribute to less swelling of the membrane in ethanol/toluene mixtures. With the introduction of acetyl groups into the matrix of chitosan, the chemical structure of the chitosan membrane becomes bulky and stiff, resulting in a mechanically brittle acetylated chitosan. By virtue of the bulky acetyl groups, chain mobility of the membrane may have been substantially hindered, thereby reducing the free volume available to accommodate a permeating component.

With respect to the acetylated membrane in 7 mol acetic anhydride per glucosamine (about 90% degree of acetylation), permeation flux increases to the minimal extent through the whole feed concentration range. Without wishing to be bound by theory, this is probably due to its rigid structure which is negligibly swollen in the feed mixtures. In fact, 7 mol of acetic anhydride per glucosamine was the maximum amount of acetic anhydride which could be reacted with the intermediate composite membrane (ie. the pre-cursor composite membrane with substantially unacetylated chitosan) in order to form a suitable membrane for the pervaporation separation of ethanol/toluene mixture. 10 mol of acetic anhydride per glucosamine was attempted, but this was proven to be excessive because the membrane acetylated with 10 mol was overly rigid and brittle. Notably, there was almost no transport through this membrane.

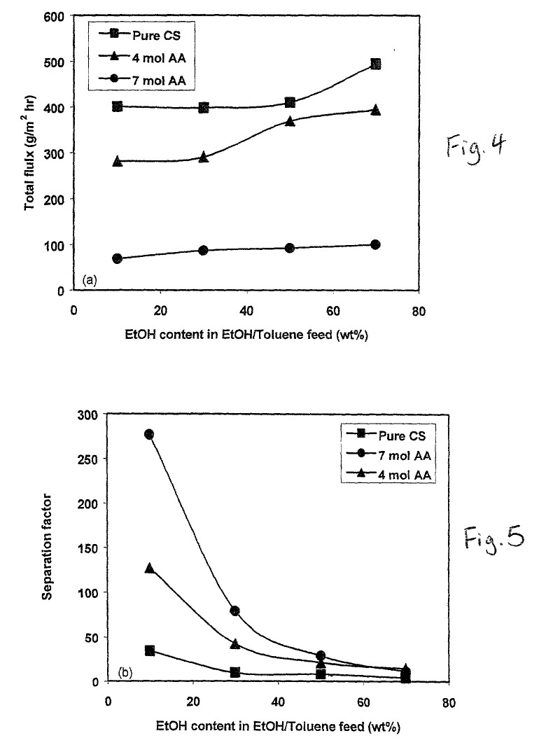

Referring to FIG. 5, it is apparent that separation factor increases with increase of N-acetylation degree for the whole feed concentration range. The introduction of acetyl groups to the chitosan structure tends to hinder permeation and, therefore, the speed of transport of both ethanol and toluene. This is especially the case with respect to the transport of toluene, as toluene is characterized by relatively large molecular size and is less polar than ethanol.

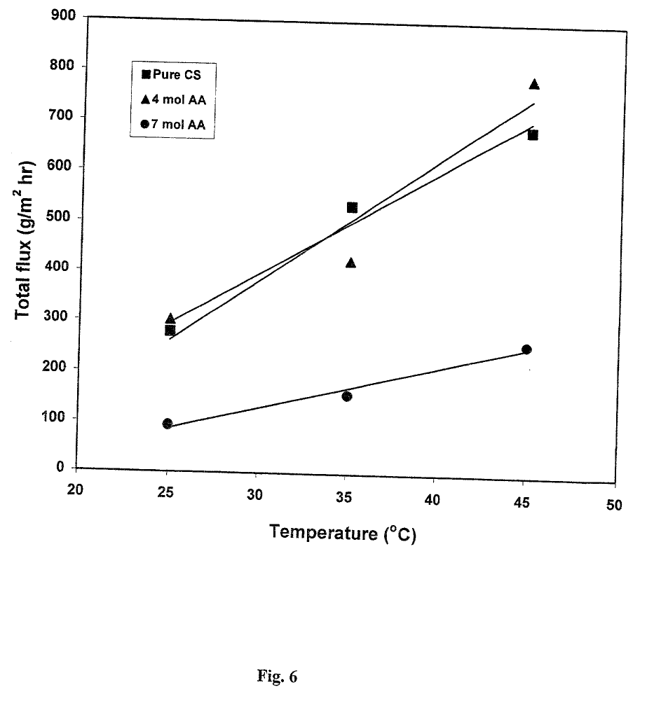

FIG. 6 illustrates the relationship between the total flux and temperature. As expected, fluxes increase with increasing feed temperature for all membranes tested. It is interesting that flux increase of the membrane acetylated in 7 mol acetic anhydride per glucosamine (about 90% degree of N-acetylation) is less pronounced than those of the pure chitosan and the membrane acetylated in 4 mol acetic anhydride per glucosamine (about 70% degree of N-acetylation).

Without wishing to be bound by theory, it is believed that the incorporation of acetyl groups into the chitosan backbone restricts the thermal mobility of the membrane, resulting in lower fluxes as the degree of acetylation of the membrane increases. Also, it is evident that there is no large difference in flux between 70% acetylated membrane (acetylated in 4 mol acetic anhydride) and pure chitosan membrane. Without wishing to be bound by theory, it is believed that the 70% acetylated membrane is still characterized by a relatively loosened membrane structure.

### EXAMPLE 2

Pervaporation separation of toluene/methanol mixtures were carried out with the N-acetylated chitosan composite membranes and pure chitosan composite membrane prepared and tested in Example 1. Toluene/methanol mixtures are known to be difficult to separate.

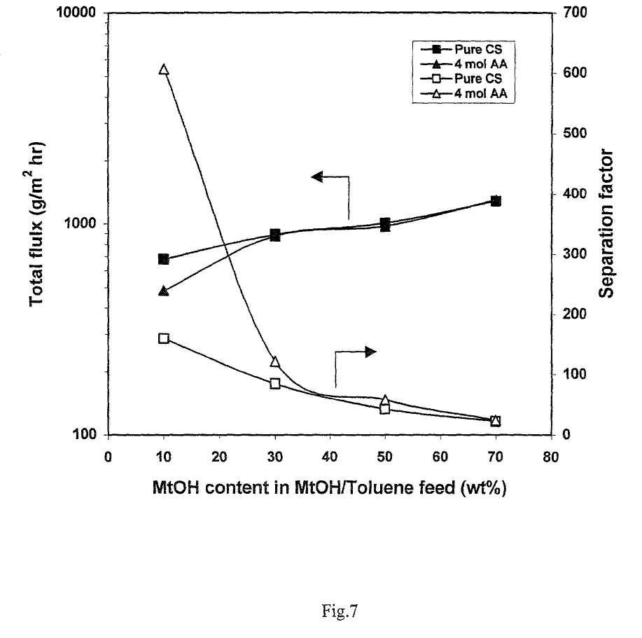

Pervaporation results for the membranes are illustrated in FIG. 7. The total flux of methanol/toluene mixture, as illustrated in FIG. 7, is much larger than that for the pervaporation of the ethanol/toluene mixtures, as illustrated in FIGS. 4 and 5. Without wishing to be bound by theory, it is believed that the small molecular size of methanol compared to ethanol played a positive role in the increased flux. Having said that, methanol is a relatively polar solvent among most of solvents, although the polarity of methanol is less than that of water. Therefore, it is believed that methanol in the feed mixture swells the membrane much more than ethanol in the feed mixture due to its larger polarity. The total flux of methanol/toluene mixture increases with the methanol content in the feed proportionally. In case of the acetylated membrane in 4 mol acetic anhydride per repeating unit of chitosan, trend of flux increase is somewhat similar to that of pure chitosan. However, the total flux is still lower than that of the pure chitosan membrane due to the introduction of rigid acetyl functional group, although the flux difference is less pronounced compared to that of ethanol/toluene mixture. Relatively good separation factor is achieved for each of the modified and unmodified chitosan membranes.

In view of the above-described experimental results, it has been shown that N-acetylated chitosan membranes exhibit relatively good permselectivity during pervaporation of alcohol/toluene mixtures. The N-acetylation reaction is a good strategy to make chitosan membranes stronger, chemically resistant and efficient for the separation of alcohol/toluene mixtures. The N-acetylation reaction of chitosan composite membranes affects membrane performance in a manner analogous to that of chemical cross-linking of dehydration membranes. Chemical cross-linking of dehydration membranes typically results in reduced permeation fluxes and increased separation factors. This performance “trade-off” is similarly evident with the N-acetylation of chitosan composite membranes

It will be understood, of course, that modifications can be made in the embodiments of the invention described herein without departing from the scope and purview of the invention. For a complete definition as to the scope of the invention, reference is to be made to the appended claims.

1. A composite membrane comprising a first membrane comprising N-acetylated chitosan deposited on a porous substrate.

2. The composite membrane as claimed in claim 1, wherein the N-acetylated chitosan is characterized by a degree of N-acetylation greater than 50%.

3. The composite membrane as claimed in claim 1, wherein the N-acetylated chitosan is characterized by a degree of N-acetylation within the range of from about 50% to about 90%.

4. The composite membrane as claimed in claim 1, wherein the porous substrate includes a porous substrate membrane, and wherein the first membrane is deposited upon the porous substrate membrane.

5. The composite membrane as claimed in claim 4, wherein the porous substrate membrane includes at least one of polyetherimide, polyvinylidene fluoride, polysulfone, polyether sulfone, polyacrylonitrile and a ceramic.

6. The composite membrane as claimed in claim 1, wherein the porous substrate includes a porous substrate membrane deposited on a polyesternon-woven fabric.

7. A composite membrane comprising chitin deposited on a porous substrate membrane.

8. A composite membrane comprising:
a first layer including N-acetylated chitosan; and
a second layer including a porous substrate membrane;
wherein the first layer is deposited upon the second layer.

9. The membrane as claimed in claim 8, wherein the N-acetylated chitosan is characterized by a degree of N-acetylation greater than 50%.

10. The membrane as claimed in claim 8, wherein the N-acetylated chitosan is characterized by a degree of N-acetylation within the range of from about 50% to about 90%.

11. A composite membrane comprising:
a first layer including chitin; and
a second layer including a porous substrate membrane;
wherein the first layer is deposited upon the second layer.

12. A method of forming a composite membrane comprising the steps of:
(i) forming a porous substrate membrane;
(ii) depositing chitosan solution on the porous substrate membrane to form a first intermediate;
(iii) drying the first intermediate to form an intermediate composite membrane including a chitosan membrane; and
(iv) converting the chitosan membrane to a chitin membrane.

13. The method as claimed in claim 10, wherein the chitosan membrane is converted to a chitin membrane by acetylation.

14. The method as claimed in claim 13, wherein the intermediate composite membrane is immersed in a solution comprising acetyl radicals or acetyl groups for acetylating the chitosan membrane.

15. The method as claimed in claim 14, wherein the solution comprises acetic anhydride or acetyl chloride.

16. The method as claimed in claim 13, wherein the intermediate composite membrane is immersed in a solution comprising no more than 7 mol. acetic anhydride per glucosamine.

17. A method for separating a liquid mixture including a polar liquid and a non-polar liquid, comprising the steps of:
providing a composite membrane comprising a first layer including N-acetylated chitosan, and a second layer including a porous substrate membrane, wherein the first layer is deposited upon the second layer; and
contacting the mixture with the first layer of the composite membrane.

18. The method as claimed in claim 17, wherein the non-polar liquid is an organic liquid.

19. The method as claimed in claim 18, wherein the liquid is aromatic.

20. The method as claimed in claim 19, wherein the polar liquid is an alcohol.

21. A composite membrane comprising a first membrane including N-acetylated chitosan, and a porous substrate, wherein the first membrane is physically adhered to the porous substrate.
